(19) United States
(12) Patent Application Publication
(10) Pub. No.: US 2015/0338957 A1
(43) Pub. Date: Nov. 26, 2015

(54) TOUCH PANEL HAVING BUFFER LAYER AND MANUFACTURING METHOD THEREOF

(71) Applicant: Henghao Technology Co., Ltd., Hsinchu County (TW)

(72) Inventor: Ting-Chieh Chen, Hsinchu County (TW)

(73) Assignee: Henghao Technology Co., Ltd.

(21) Appl. No.: 14/709,063

(22) Filed: May 11, 2015

(30) Foreign Application Priority Data
May 26, 2014 (TW) 103118331

(51) Int. Cl. G06F 3/044

(52) U.S. Cl. CPC G06F 3/044; G06F 2203/04103; G06F 2203/04112

(57) ABSTRACT

Configurations of a touch panel having a buffer layer and a manufacturing method thereof are disclosed. The proposed touch panel has a touch sensor, wherein the touch sensor includes a sensing electrode, a buffer layer configured on the sensing electrode, and a metal signal line configured on the buffer layer.

### CROSS-REFERENCES TO RELATED APPLICATIONS

This application claims the benefits of Taiwan Patent Application Number 103118331 filed on May 26, 2014, at the Taiwan Intellectual Property Office, the disclosures of which are incorporated herein in their entirety by reference.

### FIELD OF THE INVENTION

The present invention relates to a touch panel and a manufacturing method thereof, in particular to a touch panel having a buffer layer and a manufacturing method thereof.

### BACKGROUND OF THE INVENTION

In prior art for manufacturing touch sensor for touch panels, while transparent conductive materials are used to manufacture electrodes for the view area, high conductivity materials (e.g., Ag/Cu/Mo/Al) are also used to guide the signals from the view area to the signal outlet, and FPC is used to connect the signals to the IC. FIG. 1 shows a top view diagram of a touch panel in the prior art. The touch panel 1 includes a plurality of sensing electrodes 111 in the view area and a plurality of metal signal lines 112 in the peripheral area, wherein for each of the plurality of sensing electrodes 111, a corresponding metal signal line 112 is configured thereon. FIG. 2 shows a schematic diagram of a touch panel in the prior art. In FIG. 2, the touch panel 1 includes a subsrate 113 and a touch sensor 11, wherein the touch sensor 11 includes a sensing electrode 111, a metal signal line 112 configured thereon. As shown in FIG. 2, the sensing electrode 111 and the metal signal line 112 are disposed on the substrate 113.

However, if the respective materials of the metal signal line and that of the sensing electrode included in the touch panel are similar to each other, it is easy to generate electron ionization between these two. When the sensing electrode uses Nano Silver, and the metal signal line configured thereon is made of a similar or same material (e.g. including the silver component), the silver included in the sensing electrode and the metal signal line will be ionized following the flow of the current so as to cause the failure of the connection between the sensing electrode and the metal signal line. Thus, how to increase the adhesive force between the metal signal line and the sensing electrode and to increase the stability of transmission signals between the metal signal line and the sensing electrode are worthy of further research and improvement.

Keeping the drawbacks of the prior art in mind, and through the use of robust and persistent experiments and research, the applicant has finally conceived of a touch panel having a buffer layer and a manufacturing method thereof.

### SUMMARY OF THE INVENTION

It is therefore an objective of the present invention to provide a touch panel comprising a touch sensor wherein the touch sensor includes a sensing electrode, a buffer layer configured on the sensing electrode, and a metal signal line configured on the buffer layer to increase an adhesive force between the sensing electrode and the metal signal line, and a stability of transmission signals between the sensing electrode and the metal signal line is increased because of a relatively high stability of the buffer layer.

In accordance with the first aspect of the present invention, a touch panel comprises a subsrate and a touch sensor wherein the touch sensor includes a sensing electrode configured on the substrate, a metal signal line and a buffer layer configured on the sensing electrode and configured thereon the metal signal line, wherein the metal signal line is electrically connected to the sensing electrode.

In accordance with the second aspect of the present invention, a touch panel comprises a touch sensor wherein the touch sensor includes a sensing electrode, a buffer layer configured on the sensing electrode, and a metal signal line configured on the buffer layer.

In accordance with the third aspect of the present invention, a touch panel comprises a touch sensor, wherein the touch sensor includes a sensing electrode, a metal signal line and a buffer layer configured between the sensing electrode and the metal signal line.

In accordance with the fourth aspect of the present invention, a touch panel comprises a touch sensor wherein the touch sensor includes a sensing electrode, a metal signal line, and an adhesion-intensifying device configured between the sensing electrode and the metal signal line to secure the electrical connection therebetween.

In accordance with the fifth aspect of the present invention, a manufacturing method for a touch panel comprises configuring a sensing electrode on a substrate; configuring a buffer layer on the sensing electrode; and configuring a metal signal line on the buffer layer, wherein the metal signal line is electrically connected to the sensing electrode with the buffer layer disposed therebetween.

### BRIEF DESCRIPTION OF THE DRAWINGS

Other objectives, advantages and efficacy of the present invention will be described in detail below taken from the preferred embodiments with reference to the accompanying drawings, in which:

FIG. 1 is a top view diagram of a touch panel in the prior art.

FIG. 2 is a schematic diagram of a touch panel in the prior art.

FIG. 3 is a schematic diagram of a touch panel according to the preferred embodiment of the present invention.

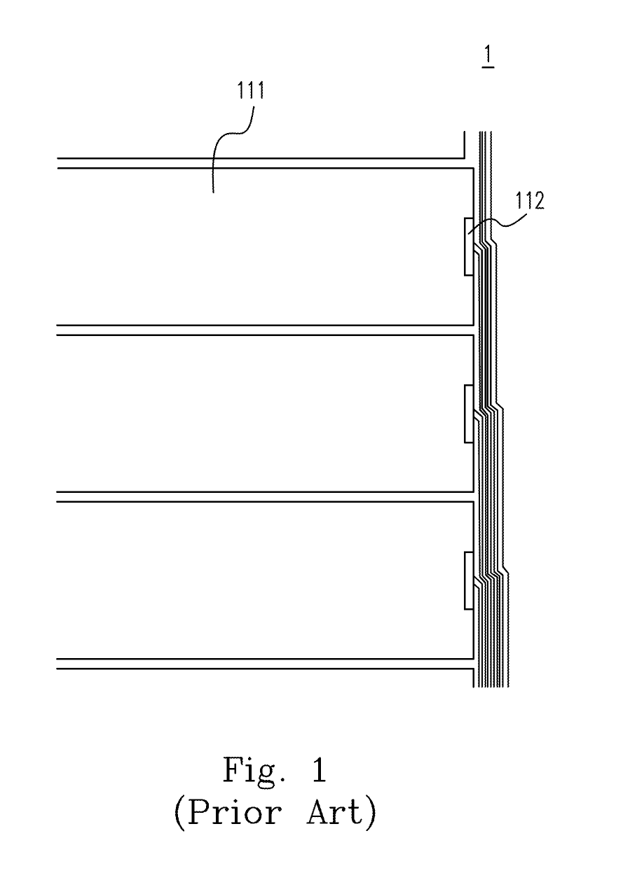

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

FIG. 3 shows a schematic diagram of a touch panel according to the preferred embodiment of the present invention. In FIG. 3, the touch panel 2 includes a substrate 113 and a touch sensor 21, the touch sensor 21 includes a sensing electrode 111, a buffer layer 211 configured on the sensing electrode 111, a metal signal line 112 configured on the buffer layer 211, wherein the sensing electrode 111, the buffer layer 211 and the metal signal line 112 are disposed on the substrate 113.

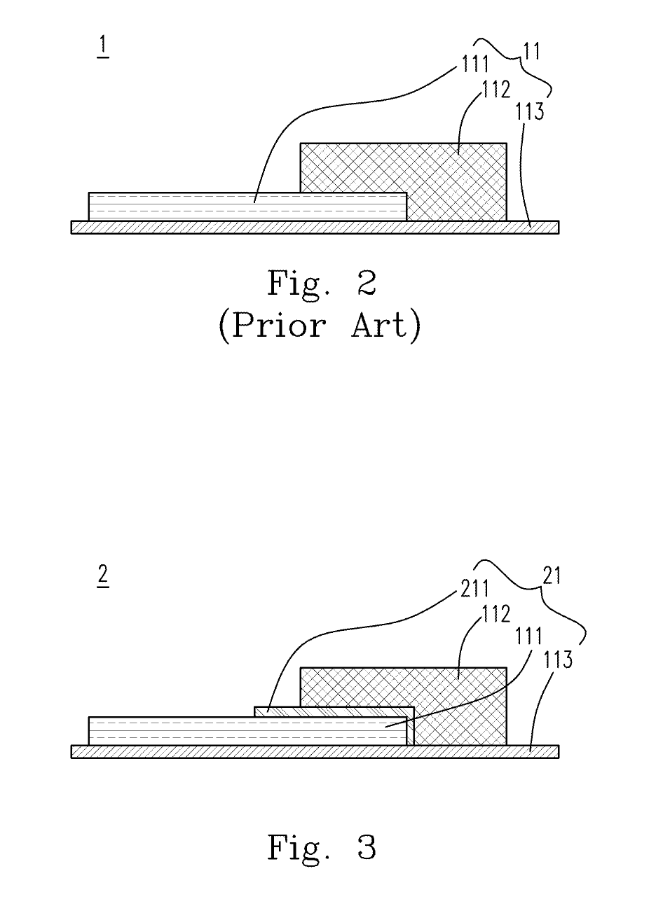

As shown in FIG. 3, the buffer layer 211 includes a conductive inorganic material, for example, a carbogel. Thus, the adhesive force between the metal signal line 112 and the sensing electrode 111, and a stability of transmission signals between the sensing electrode and the metal signal line is increased because of a relatively high stability of the buffer layer. And, because the material of the buffer layer 211 is different from those of the sensing electrode 111 and the metal signal line 112, a buffer action is generated so as to avoid the problem as shown in FIG. 2 that the materials of the metal signal line 112 and that of the sensing electrode 111 included in the touch sensor 11 are similar to each other, which causes the electron ionization therebetween to result in the failure of the connection between the sensing electrode and the metal signal line. The substrate 113 includes a transparent material, for example, a glass, transparent plastic substrate or the combination of the glass and the plastic.

That is to say, according to the preferred embodiment of the present invention, the buffer layer 211 as shown in FIG. 3 is an adhesion intensifying device configured between the sensing electrode and the metal signal line to intensify the electrical connection therebetween. Certainly, if other processing methods can be used to cause the adhesion of the sensing electrode 111 and the metal signal line 112 to have better adhesive force, then the same purpose of intensifying the adhesive force between the sensing electrode 111 and the metal signal line 112 can also be achieved (e.g., when the sensing electrode 111 and the metal signal line 112 have a concave shape and a convex shape respectively to fit with each other, and are tightly connected so as to increase the adhesive force therebetween).

### EMBODIMENTS

1. A touch panel comprising a substrate and a touch sensor wherein the touch sensor includes:

a sensing electrode configured on the substrate;

a metal signal line; and

a buffer layer configured on the sensing electrode and configured thereon the metal signal line, wherein the metal signal line is electrically connected to the sensing electrode.

2. A touch panel comprising a touch sensor wherein the touch sensor includes:

a sensing electrode;

a buffer layer configured on the sensing electrode; and

a metal signal line configured on the buffer layer.

3. A touch panel according to Embodiment 2, wherein the buffer layer includes a conductive inorganic material.

4. A touch panel according to Embodiment 2 or 3, wherein the conductive inorganic material is a carbogel.

5. A touch panel according to any one of the above-mentioned Embodiments, wherein the buffer layer increases an adhesive force between the sensing electrode and the metal signal line, and a stability of transmission signals between the sensing electrode and the metal signal line is increased because of a relatively high stability of the conductive inorganic material.

6. A touch panel according to any one of the above-mentioned Embodiments, wherein the metal signal line has a first thickness ranged between 3 and 15 μm, the buffer layer has a second thickness ranged between 3 and 15 μm, and the sensing electrode has a third thickness less than 7 μm.

7. A touch panel comprising a touch sensor wherein the touch sensor includes:

a sensing electrode;

a metal signal line; and

a buffer layer configured between the sensing electrode and the metal signal line.

8. The touch panel according to Embodiment 7, wherein the buffer layer is tightly connected to the sensing electrode and the metal signal line, the buffer layer is a conductive inorganic material used to increase an adhesive force between the sensing electrode and the metal signal line, and a stability of transmission signals between the sensing electrode and the metal signal line is increased because of a relatively high stability of the conductive inorganic material.

9. The touch panel according to Embodiment 7 or 8, wherein the metal signal line has a first thickness ranged between 3 and 15 μm, the buffer layer has a second thickness ranged between 3 and 15 μm, and the sensing electrode has a third thickness less than 7 μm.

10. A touch panel comprising a touch sensor wherein the touch sensor includes:

a sensing electrode;

a metal signal line; and

an adhesion-intensifying device configured between the sensing electrode and the metal signal line to secure the electrical connection therebetween.

11. A manufacturing method for a touch panel, comprising:

configuring a sensing electrode on a substrate;

configuring a buffer layer on the sensing electrode; and

configuring a metal signal line on the buffer layer wherein the metal signal line is electrically connected to the sensing electrode with the buffer layer disposed therebetween.

12. The manufacturing method according to Embodiment 11, wherein the touch panel includes a touch sensor, the touch sensor includes the sensing electrode, the buffer layer and the metal signal line, the buffer layer includes a conductive inorganic material, and the buffer layer is tightly disposed between the sensing electrode and the metal signal line.

According to the above-mentioned descriptions, the present invention discloses a touch panel comprising a touch sensor wherein the touch sensor includes a sensing electrode, a buffer layer configured on the sensing electrode, and a metal signal line configured on the buffer layer to increase an adhesive force between the sensing electrode and the metal signal line, and a stability of transmission signals between the sensing electrode and the metal signal line is increased because of a relatively high stability of the buffer layer, which demonstrates the non-obviousness and novelty.

While the invention has been described in terms of what is presently considered to be the most practical and preferred embodiments, it is to be understood that the invention needs not be limited to the disclosed embodiments. Therefore, it is intended to cover various modifications and similar configuration included within the spirit and scope of the appended claims, which are to be accorded with the broadest interpretation so as to encompass all such modifications and similar structures.

What is claimed is:

1. A touch panel comprising a touch sensor wherein the touch sensor includes:
a sensing electrode;
a buffer layer configured on the sensing electrode; and
a metal signal line configured on the buffer layer.

2. The touch panel according to claim 1, wherein the metal signal line is electrically connected to the sensing electrode.

3. The touch panel according to claim 1, wherein the buffer layer includes a conductive inorganic material.

4. The touch panel according to claim 3, wherein the conductive inorganic material is a carbogel.

5. The touch panel according to claim 1, wherein the metal signal line has a first thickness ranged between 3 and 15 μm, the buffer layer has a second thickness ranged between 3 and 15 μm, and the sensing electrode has a third thickness less than 7 μm.

6. The touch panel according to claim 1, further comprising a substrate, wherein the sensing electrode is disposed on the substrate.

7. The touch panel according to claim 1, wherein the buffer layer is configured between the sensing electrode and the metal signal line, and the buffer layer is a conductive inorganic material used to increase an adhesive force between the sensing electrode and the metal signal line.

8. A touch panel comprising a touch sensor wherein the touch sensor includes:
a sensing electrode;
a metal signal line; and
an adhesion-intensifying device configured between the sensing electrode and the metal signal line to secure the electrical connection therebetween.

9. The touch panel according to claim 8, wherein the adhesion-intensifying device is a buffer layer.

10. A manufacturing method for a touch panel, comprising:
configuring a sensing electrode on a substrate;
configuring a buffer layer on the sensing electrode; and
configuring a metal signal line on the buffer layer, wherein the metal signal line is electrically connected to the sensing electrode with the buffer layer disposed therebetween.

11. The manufacturing method according to claim 10, wherein the touch panel includes a touch sensor, the touch sensor includes the sensing electrode, the buffer layer and the metal signal line, the buffer layer includes a conductive inorganic material, and the buffer layer is tightly configured between the sensing electrode and the metal signal line.
